(19) United States
(12) Patent Application Publication
(10) Pub. No.: US 2019/0089900 A1
(43) Pub. Date: Mar. 21, 2019

(54) SYSTEM AND METHOD FOR GENERATING 360 DEGREE VIDEO

(71) Applicant: 3i, Corporation, Daegu (KR)

(72) Inventor: Ji Wuck JUNG, Daegu (KR)

(21) Appl. No.: 16/136,217

(22) Filed: Sep. 19, 2018

(30) Foreign Application Priority Data
Sep. 20, 2017 (KR) 10-2017-0121034

(51) Int. Cl. H04N 5/232

(52) U.S. Cl. CPC H04N 5/23238; H04N 5/23299

(57) ABSTRACT

A method for generating 360° video may include: obtaining, by a 360 video generation system, a first partial image to an N-th partial image, wherein an i-th partial image (i is any natural number greater than or equal to 1 and smaller than or equal to N) may be image shot toward i-th shooting direction at a predetermined shooting position, and a first shooting direction to a N-th shooting direction may be all in different directions; generating, by a 360° video system, a 360° image by registering the first partial image to the N-th partial image; obtaining, by a 360° video system, a plurality of video frame images shot toward a target direction which is any one of the first shooting direction to the N-th shooting direction; and generating a 360° video based on the plurality of video frame images and the 360° image.

### CROSS REFERENCE TO RELATED APPLICATION

This application claims priority form and the benefit of Korean Patent Application No. 10-2017-0121034, filed on Sep. 20, 2017, which is hereby incorporated by reference for all purposes as if fully set forth in.

### BACKGROUND

### Field

Exemplary embodiments of the invention relate generally to a system and method for generating 360° video and, more specifically, to system and method capable of producing 360° video by shooting only toward specific direction not toward the omni-direction of 360° video's coverage.

### Discussion of the Background

Attempts have been made to create a registered image to provide a virtual reality (VR) or a realistic simulation environment.

For example, a panoramic image may mean an image that can cover 180 to 360 degrees of horizontal viewing angle by combining a plurality of images horizontally (left and right side). In addition, a 360° image may mean an image that can be covered all of left, right, up, and down side from a user position or a specific position. Conventionally, the 360° image may be generated by taking a plurality of images taken by rotating at some landscape or at some indoor, connecting them to each other through an image processing process, and disposing the connected images at a spherical, cylindrical shape, or a Mercator projection.

On the other hand, unlike a conventional video with a fixed view point selected by the video recorder, a 360° video may be video that may cover all of left, right, up, and down side from a user position or a specific position, and the user may select a direction and a point that the user wants to see during playback.

Conventionally, a 360° video is generated by a process of synchronizing timelines between moving images shot by a plurality of cameras and stitching adjacent moving images, or stitching images shot by a plurality of cameras to generate video frame images which make up the 360° video.

Such conventional 360° video generation technology requires very large resources, and therefore requires dedicated equipment with large computing power and long generation time.

The above information disclosed in this Background section is only for understanding of the background of the inventive concepts, and, therefore, it may contain information that does not constitute prior art.

### SUMMARY

Devices constructed and methods according to exemplary embodiments of the invention are capable of providing a system and method for generating 360° video using relatively reduced resources.

Particularly, the exemplary embodiments may provide a method and system for easily and relatively accurately generating 360° video using a terminal carried by a user. Also, the exemplary embodiments may provide a system and method for generating 360° video by shooting in a specific direction, not all directions covered by 360° video.

Additional features of the inventive concepts will be set forth in the description which follows, and in part will be apparent from the description, or may be learned by practice of the inventive concepts.

According to one or more embodiments of the invention, a method for generating 360° video may include: obtaining, by a 360 video generation system, a first partial image to an N-th partial image (N is a natural number greater than or equal to 2), wherein an i-th partial image (i is any natural number greater than or equal to 1 and smaller than or equal to N) may be image shot toward i-th shooting direction at a predetermined shooting position, and a first shooting direction to a N-th shooting direction may be all in different directions; generating, by a 360° video system, a 360° image by registering the first partial image to the N-th partial image; obtaining, by a 360° video system, a plurality of video frame images shot toward a target direction which is any one of the first shooting direction to the N-th shooting direction; and generating a 360° video based on the plurality of video frame images and the 360° image.

The obtaining of the first partial image to the N-th partial image may include: obtaining, by a 360° video generation system, the first partial image to the Nth partial image shot on a terminal equipped with an image sensor, wherein the terminal may be configured to obtain the first partial image by shooting toward the first shooting direction at the shooting position, sequentially rotate and shoot a second partial image through the Nth partial image by controlling a driving apparatus coupled to the terminal and capable of rotating the terminal, and wherein the terminal may be configured to control, for shooting a j-th partial image (j is any natural number greater than or equal to 2 and smaller than or equal to N), the driving apparatus such that the terminal facing a (j−1)-th shooting direction after shooting a (j−1)-th partial image faces a j-th shooting direction, and obtain a j-th partial image by shooting toward the j-th shooting direction.

The obtaining of the first partial image to the N-th partial image may include, obtaining, by the 360° video generation system, the first partial image to the Nth partial image shot on a terminal equipped with an image sensor, and wherein the method may further include: further obtaining a first additional partial image to the a N-th additional partial image further shoot at the terminal, wherein an i-th additional partial image (i is any natural number greater than or equal to 1 and smaller than or equal to N) may be shot toward an i-th shooting direction at the shooting position; and specifying the target direction which is any one of the first shooting direction to the N-th shooting direction by comparing each of the first partial image to the Nth partial image with the additional partial image corresponding thereto.

The method for generating 360° video may further include, determining, by the 360° video generation system, a specific shooting direction as the target direction wherein a partial image corresponding to the specific shooting direction among the first partial image to the Nth partial image may be taken of a predetermined specific object.

The operation of generating 360° video based on the plurality of video frame images and the 360° image may include wherein for each of the plurality of video frame images, generating a 360° video frame corresponding to each of the plurality of video frame images by registering the 360° image and the each of the plurality of video frame images, by the 360° video generation system.

The operation of generating the 360° video frame corresponding to each of the plurality of video frame images by registering the 360° image and the each of the plurality of video frame images may include, generating the 360° video frame corresponding to each of the plurality of video frame images by registering each of the plurality of video frame images to a portion of the 360° image corresponding to partial image corresponding to the target direction.

According to one or more embodiments of the invention, a non-transitory computer-readable storage medium having stored thereon processor-executable instructions may be configured to cause a processor to perform the above method for generating 360° video.

According to one or more embodiments of the invention, a 360° video generation system may include: a processor; and a memory for storing a computer program executed by the processor; wherein the computer program may include instructions, when executed by the processor, configured to cause the 360° video generation system to execute the above method for generating 360° video.

According to one or more embodiments of the invention, a 360° video generation system may include: an image obtaining module configured to obtain a first partial image to an N-th partial image (N is a natural number greater than or equal to 2), wherein an i-th partial image (i is any natural number greater than or equal to 1 and smaller than or equal to N) may be image shot toward i-th shooting direction at a predetermined shooting position, and a first shooting direction to a N-th shooting direction may be all in different directions; an image generating module configured to generate a 360° image by registering the first partial image to the N-th partial image; a video frame obtaining module configured to obtain a plurality of video frame images shot toward a target direction which is any one of the first shooting direction to the N-th shooting direction; and a video generating module configured to generate a 360° video based on the plurality of video frame images and the 360° image.

The image obtaining module may be configured to obtain the first partial image to the N-th partial image shot on a terminal equipped with an image sensor, wherein the terminal may be configured to obtain the first partial image by shooting toward the first shooting direction at the shooting position, sequentially rotate and shoot a second partial image through the N-th partial image by controlling a driving apparatus coupled to the terminal and capable of rotating the terminal, and wherein the terminal may be configured to control, for shooting a j-th partial image (j is any natural number greater than or equal to 2 and smaller than or equal to N), the driving apparatus such that the terminal facing a (j−1)-th shooting direction after shooting a (j−i)-th partial image faces a j-th shooting direction, and obtain the j-th partial image by shooting toward the j-th shooting direction.

The image obtaining module may be configured to: obtain the first partial image to the N-th partial image shot on a terminal equipped with an image sensor; and obtain a first additional partial image to an Nth additional partial image further shot at the terminal, wherein an i-th additional partial image (i is any natural number greater than or equal to 1 and smaller than or equal to N) may be shot toward the i-th shooting direction at the shooting position, wherein the 360° video generation system may further include a specification module configured to specify the target direction which is any one of the first shooting direction to the N-th shooting direction by comparing each of the first partial image to the N-th partial image with the additional partial image corresponding thereto.

The 360° video generation system may further include a specification module configured to determine a specific shooting direction as the target direction wherein the partial image corresponding to the specific shooting direction among the first partial image to the Nth partial image may be taken of a predetermined specific object.

The video generation module, for each of the plurality of video frame images, may be configured to generated a 360° video frame corresponding to each of the plurality of video frame images by registering the 360° image and the each of the plurality of video frame images.

The video generation module, for generating the 360° video frame corresponding to each of the plurality of video frame images by registering the 360° image and the each of the plurality of video frame images, may be configured to generate the 360° video frame corresponding to each of the plurality of video frame images by registering each of the plurality of video frame images to a portion of the 360° image corresponding to the partial image corresponding to the target direction.

It is to be understood that both the foregoing general description and the following detailed description are exemplary and explanatory and are intended to provide further explanation of the invention as claimed.

### DESCRIPTION OF DRAWINGS

The accompanying drawings, which are included to provide a further understanding of the invention and are incorporated in and constitute a part of this specification, illustrate exemplary embodiments of the invention, and together with the description serve to explain the inventive concepts.

FIGS. 1A and 1B are schematic diagrams for explaining an operation environment of a 360° video generation system according to exemplary embodiments.

FIG. 2 is a schematic block diagram illustrating a configuration of a 360° video generation system according to an exemplary embodiment.

FIG. 3 is a diagram for explaining an example of shooting partial images in each shooting direction.

FIG. 4 is a diagram illustrating a terminal and accessories for shooting partial images to be registered according to an exemplary embodiment.

FIG. 5 is a flow chart illustrating an exemplary process of registering partial images shot by the terminal of FIG. 4.

FIG. 6A shows six partial images first shot in six different shooting directions, and FIG. 6B shows six additional partial images further shot after partial images of FIG. 6A are shot.

FIG. 7 is a diagram showing a 360° image according to an exemplary embodiment.

FIG. 8 is a diagram showing each 360° video frame constituting a 360° video.

FIG. 9 is a flowchart illustrating a 360° video generation method according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Also, in the present specification, when any one element ‘transmits’ data to another element, the element may transmit the data directly to the other element or may be transmitted through at least one other element. Conversely, when one element ‘directly transmits’ data to another element, it means that the data is transmitted to the other element without passing through another element in the element.

Hereinafter, embodiments will be described in detail with reference to the accompanying drawings. Like reference symbols in the drawings denote like elements.

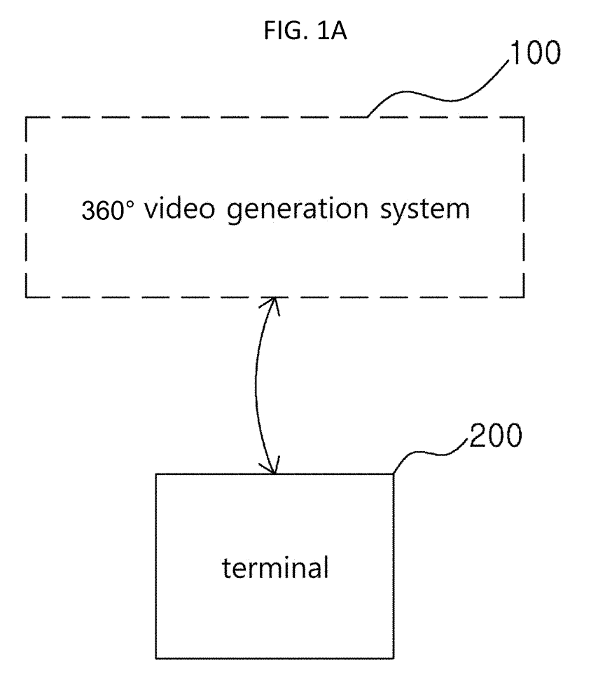

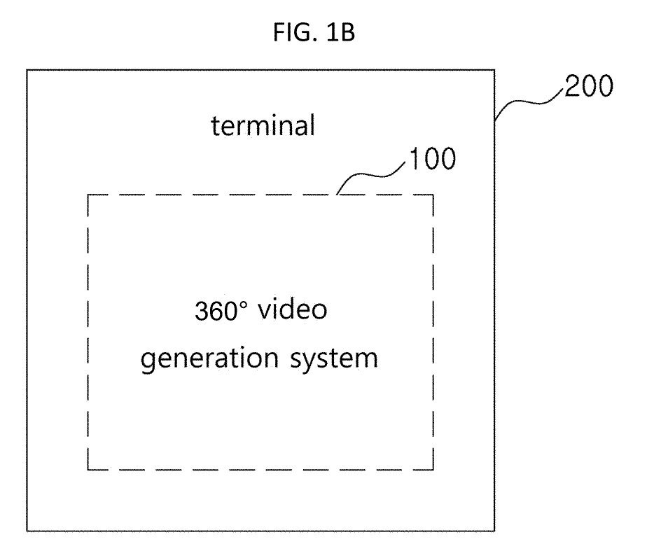

FIGS. 1A and 1B are a schematic diagram for explaining an operation environment of a 360° video generation system according to an exemplary embodiment. In order to implement the 360° video generation method according to the technical idea, a 360° video generation system 100 may be provided. The 360° video generation system 100 may generate 360° video.

As shown in FIG. 1A, the 360° video generation system 100 is connected to the terminal 200 through wired/wireless communication to transmit/receive various data, information, and/or signals necessary for implementing the technical idea. For example, the 360° video generation system 100 may receive image and/or video data shot by the terminal 200, and the 360° video generation system 100 may transmit the generated 360° to the terminal 200. In the embodiment of FIG. 1A, the 360° video generation system 100 may embodied in a server.

As shown in FIG. 1B, the 360° video generation system 100 may be implemented in the form of being included in the terminal 200. According to an exemplary embodiment, the 360° video generation system 100 may be a kind of subsystem implemented by hardware included in the terminal 200 and/or software installed in the terminal 200.

The terminal 200 may include any type of data processing apparatus having an image sensor capable of acquiring an image. The image sensor may mean a device capable of shooting/acquiring an image.

The terminal 200 may be any data processing apparatus that computes or processes data, accepts input data and processes the data, stores the data, processes the data, and outputs a result. For example, the terminal 200 may be a general purpose computer, personal computer, server, mobile terminal, remote station, remote terminal, access terminal, terminal, communication device, communication terminal, user agent, user equipment (UE), a terminal, a notebook, a tablet PC, a smart phone, or the like.

However, the exemplary embodiments are not limited to the embodiment of FIG. 1A or 1B. The 360° video generation system 100 may be implemented in the form of an independent device that is not connected to the terminal 200 via the network or included in the terminal 200.

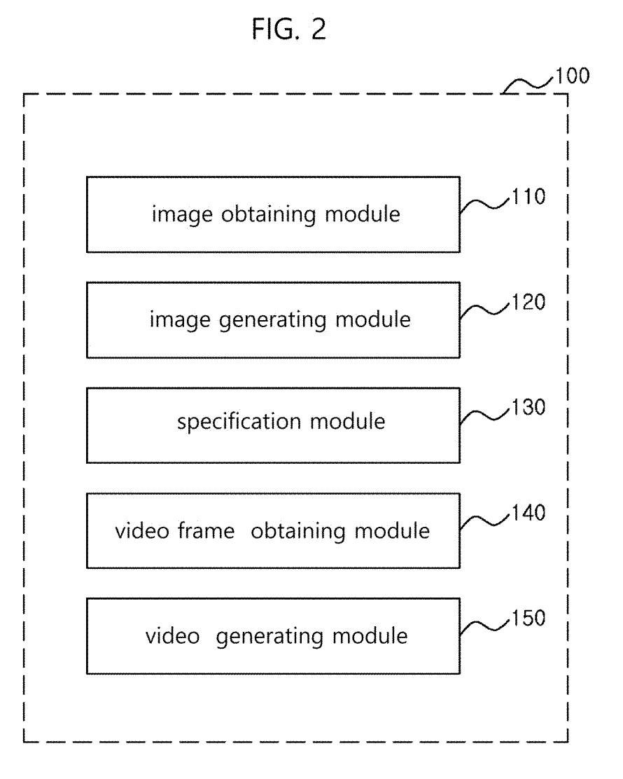

FIG. 2 is a schematic block diagram illustrating a configuration of a 360° video generation system according to an exemplary embodiment.

As shown in FIG. 2, the 360° video generation system 100 may include an image obtaining module 110, an image generating module 120, a video frame obtaining module 140, and a video generating module 150. If necessary, the 360° video generation system 100 may further include a specification module 130. According to an exemplary embodiment, some of the components of FIG. 2 may not be components that are essential to the implementation. Also If necessary, the 360° video generation system 100 may include more components. For example, the 360° video generation system 100 may include a control module (not shown) that can control the functions and/or resources of other components included in the 360° video generation system 100, such as the image obtaining module 110, the image generating module 120, the specification module 130, the video frame obtaining module 140, and/or the video generating module 150, etc.

The 360° video generation system 100 may include hardware resources and/or to software necessary to implement the technical idea, and does not need to be embodied as one physical component or one apparatus. That is, the 360° video generation system 100 may mean a logical combination of hardware and/or software provided to implement the technical idea, if necessary, may be implemented as a set of logical structures for realizing the technical idea by being installed in separate apparatuses and performing respective functions. Also, the 360° video generation system 100 may mean a set of configurations separately implemented for each function or role for implementing the technical idea. For example, the image obtaining module 110, the image generating module 120, the specification module 130, the video frame obtaining module 140 and/or the video generating module 150 may be located in different physical devices or may be located on the same physical device. According to an exemplary embodiment, the software and/or the hardware constituting each module such as the image obtaining module 110, the image generating module 120, the specification module 130, the video frame obtaining module 140, and the video generating module 150 may also be located in different physical devices, and configurations located in different physical devices may be organically coupled to each other to implement the functions performed by the respective modules.

In this specification, a module may mean a functional and structural combination of hardware for carrying out the technical idea and software for driving the hardware. For example, the module may refer to a logical unit of a predetermined code and a hardware resource to be executed by the predetermined code, and it can be easily deduced to the ordinary skilled that module does not necessarily mean a physically connected code or a kind of hardware.

The image obtaining module 110 may acquire a first partial image to an Nth partial image to be registered (N is a natural number of 2 or more), and the image generating module 120 may generate a 360° image by registering acquired the first partial image to the Nth partial images.

Each of the first partial image to the Nth partial image may be an image photographed at a predetermined shooting position. Further, each of the first partial image to the Nth partial image may be different in a shooting direction.

That is, each of the first partial image to the Nth partial image is an image taken toward the corresponding shooting direction, and the first shooting direction to the Nth shooting direction may all be different directions.

In other words, an i-th partial image (i is an arbitrary natural number with 1<=i<=N) is an image shot in an i-th shooting direction corresponding to the i-th partial image at the predetermined shooting position, and the first shooting direction to the Nth shooting direction may all be different directions.

The first partial image to the Nth partial image may be images shot by the terminal 200 having an image sensor.

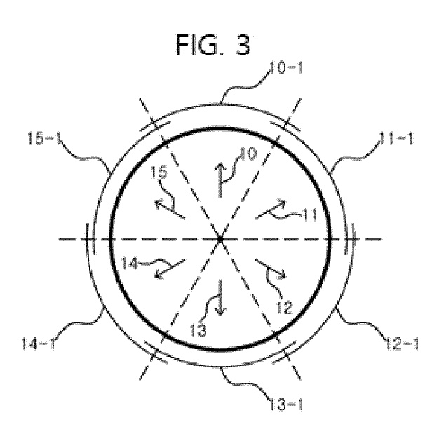

FIG. 3 is a diagram for explaining an example of shooting partial images in each shooting direction. Referring to FIG. 3, a shooting apparatus (for example, the terminal 200) illustrates rotating 60 degrees at one time and shooting six different partial images while rotating 360° degrees will be described as an example.

As shown in FIG. 3, the first partial image 10-1 may be an image shot toward the first shooting direction 10. The second partial image 11-1 may be an image shot toward the second shooting direction 11 rotated by 60 degrees from the first shooting direction 10. The third partial image 12-1 may be an image shot toward the third shooting direction 12 rotated by 60 degrees from the second shooting direction 11. The fourth partial image 13-1 may be an image shot toward the fourth shooting direction 13 rotated by 60 degrees from the third shooting direction 12. The fifth partial image 14-1 may be an image shot toward the fifth shooting direction 14 rotated by 60 degrees from the fourth shooting direction 13. The sixth partial image 15-1 may be an image shot toward the sixth shooting direction 15 rotated by 60 degrees from the fifth photographing direction 14.

Referring again to FIG. 2, the image obtaining module 110 may obtain the first partial image to the Nth partial image shot at the terminal 200. In the structure shown in FIG. 1A, the 360° video generation system 100 may receive the first partial image to the Nth partial image from the terminal 200 via a network. In the structure shown in FIG. 1B, when the terminal 200 shoots the first partial image to the Nth partial image and stores the first partial image to the Nth partial image in a storage device (not shown) in the terminal 200, then the image obtaining module 110 may obtain the first partial image to the Nth partial image from the storage device.

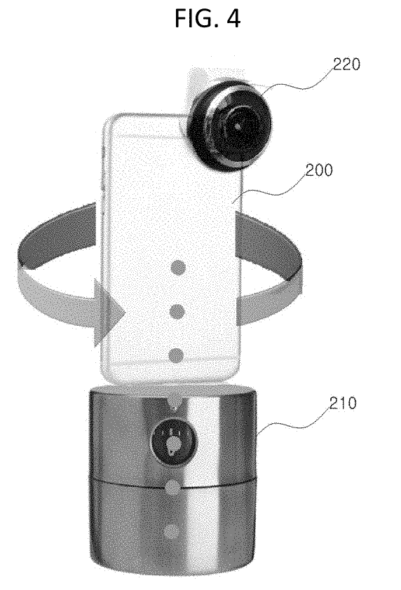

FIG. 4 is a diagram illustrating a terminal and accessories for shooting partial images to be registered according to an exemplary embodiment.

The terminal 200 may include any type of data processing apparatus including an image sensor that can be carried by the user and can acquire an image. According to an example, the terminal 200 may be a user's cellular phone, but the exemplary embodiments are not limited thereto. It should be understood that some of the technical ideas may be implemented by a device that the user cannot carry, and such a case may be included in the scope.

The terminal 200 can take images (partial images) while performing rotation. The terminal 200 may rotate 360° degrees around the terminal 200 or may not rotate 360° degrees. In any case, the terminal 200 may rotate as much as necessary to cover all the angles (e.g., 360° degrees, 270 degrees, 180 degrees, etc.) desired to cover the registered image to be generated. Of course, the degree of rotation may vary depending on the viewing angle of the image sensor provided in the terminal 200.

The terminal 200 may be attached, fastened, or coupled to a predetermined driving apparatus 210 for rotating the terminal 200. The movement of the terminal 200 may be performed through the driving apparatus 210.

The terminal 200 may control the driving apparatus 210. According to an example, the terminal 200 may perform predetermined near field communication (e.g., Bluetooth, NFC, ZigBee communication, Wi-Fi, etc.) with the driving apparatus 210. The terminal 200 can transmit a predetermined command to the driving apparatus 210, and the driving device 210 can be driven in response to the transmitted command. Also, according to the embodiment, the driving apparatus 210 may transmit the driving result of the driving performed in response to the command to the terminal 200.

The driving device 210 may be a device that performs at least rotational motion. A rotator for this rotational motion may be provided in the driving apparatus 210. Further, the driving apparatus 210 may include a predetermined fastening portion for fastening the terminal 200.

According to an example, the driving apparatus 210 may be a device capable of performing rotation in a predetermined reference unit angle, and may rotate in the command by a desired angle in response to a command received from the terminal 200. In this way, the rotation angle of the driving device 210 and/or the terminal 200 can be controlled.

According to another exemplary embodiment, the driving apparatus 210 may perform rotation in response to a command received from the terminal 200. The terminal 200 senses the degree of rotation of the driving apparatus 210 (i.e., degreed of rotation of the terminal 200), and transmits a command to stop the rotation of the driving apparatus 210 when the required angle is sensed to be rotated. In any case, the terminal 200 can control its rotation angle relatively accurately through the control of the rotation angle of the driving apparatus 210.

Herein, an example in which the driving apparatus 210 merely has a function of rotating the terminal 200 will be described, but if necessary, the driving apparatus 210 may be configured to perform a function of moving the terminal 200 or tilting the terminal 200 or changing the position of the terminal 200 up or down.

Meanwhile, the terminal 200 may be provided with a predetermined viewing angle magnifying device (e.g., a fisheye lens 220) for magnifying a viewing angle in a specific direction (e.g., up and down direction). In this case, a viewing angle up to almost 180° may be ensured by the viewing angle magnifying device. In this case, when the terminal 200 rotates so as to secure a 360° viewing angle, 360° image (a sphere image) can be generated.

As a result, according to the exemplary embodiments, the terminal 200 controls the driving device 210 to rotate the image by a desired angle relatively accurately (i.e., rotates in a desired direction) to take an image, and then the terminal 200 can rotate by a desired angle again and shoot a image. In the case where the control of the rotation angle is performed by the terminal 200 may have improved accuracy, the terminal 200 and the 360° video generation system 100 may know the rotation angle (or viewing angle) of the adjacent image more accurately, so accuracy and speed of image registration (stitching) can be improved.

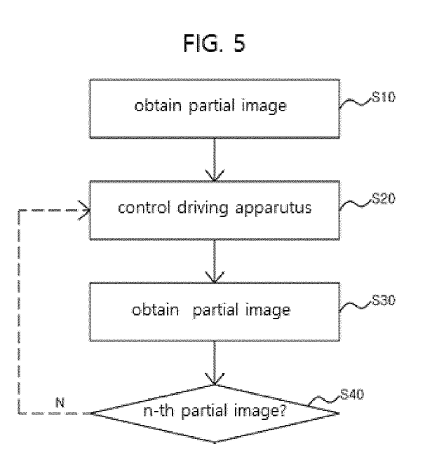

FIG. 5 is a flow chart illustrating an exemplary process in which registering partial images shot by the terminal of FIG. 4.

Referring to FIG. 5, the terminal 100 may obtain a partial image in a predetermined direction (S10). Then, the driving apparatus 200 may be controlled to perform rotation by a predetermined angle (S20). Then, the corresponding partial image can be obtained in the state where the rotation is performed (S30). Then, it is determined whether n partial images corresponding to the desired n directions have been obtained (S40). If it is determined that all the n partial images have not been obtained (S40), the terminal 100 can control the driving apparatus again to perform the rotation and obtain the partial image (S20, S30).

The following is an example of the process of shooting partial images as shown in FIG. 3 by the terminal 200 of FIG. 4.

The terminal 200 may take N (e.g., six) partial images (e.g., 10-1 through 15-1) to generate a registered image. For this, the terminal 200 may control the driving apparatus 210 to rotate in a direction toward N shooting directions (for example, 10, 11, 12, 13, 14, and 15), and then shoot a partial image in each shooting direction.

For example, the terminal 200 may shoot the first partial image 10-1 in the first photographing direction 10 and control the driving apparatus 210 to face the second shooting direction. Then, the second partial image 11-1 can be shot in the second shooting direction 11. In this way, the terminal 200 can take six partial images 10-1, 11-1, 12-1, 13-1, 14-1, and 15-1 sequentially. In this case, it is preferable that the image sensor of the terminal 200 has a viewing angle of at least 360°/N (60° in the example of FIG. 3) at least.

The terminal 200 can obtain partial images (for example, 10-1, 11-1, 12-1, 13-1, 14-1, and 15-1) sequentially through rotation and shooting, so that it is possible to know what partial images are adjacent to each other. Further, since the directions of the respective partial images are accurately known, the 360° video generation system 100 can easily determine the overlapped area between the partial images through this information, thereby performing the image registering in a relatively short period of time can do.

In order for the terminal 200 to perform the rotation, the terminal 200 may transmit a command to the driving apparatus 210 to rotate a predetermined angle (for example, 60 degrees). Upon receiving a signal indicating that the rotation has been performed from the driving apparatus 210 by the predetermined angle in response to the command, the terminal 200 can shoot a partial image.

According to another exemplary embodiment, the terminal 200 may transmit a command to the driving apparatus 210 to rotate the driving apparatus 210. When the driving apparatus 210 rotates in response to the command, the terminal 200 may sense the rotation angle. If the rotation angle corresponds to a desired angle, the terminal 200 can transmit a command to stop the rotation to the driving apparatus 210. Then, the driving apparatus 210 can stop the rotation, and the terminal 200 can shoot a partial image.

In any manner, the terminal 200 may perform a rotation by a desired angle and may shoot a partial image at an rotated angle (direction).

Referring again to FIG. 2, the image obtaining module 110 may obtain the first to the Nth partial images shot in the manner described above with reference to FIG. 5.

However, the first partial image to the Nth partial image to be registered are not shot only by the manner described above with reference to FIG. 5, and the manner of shooting the first partial image to the Nth partial image may be various. For example, the first partial image to the Nth partial image (for example, 10-1, 11-1, 12-1, 13-1, 14-1, and 15-1) may be shot by an omnidirectional camera having N number of image sensors configured to face the first to Nth shooting directions (e.g., 10, 11, 12, 13, 14, and 15). Alternatively, the terminal 200 may be connected to a rotating device such as a rotatable tripod, and the first to Nth partial images may be taken while the rotating device is rotated at a predetermined angle. Or the first partial image to the Nth partial image can be shot while rotating the terminal 200 without a separate rotating device.

The image generating module 120 may generate the 360° image (e.g., a sphere image) by registering obtained the first to the Nth partial images. The image generating module 120 may generate a 360° image using various known stitching techniques. For example, the image generating module 120 may project/distort the first to Nth partial images in a cylindrical or spherical coordinate system, extract feature points from each partial image, align adjacent partial images, perform blending process so that adjacent partial images are smoothly connected, and so on.

The specification module 130 may specify any one of the first to the Nth shooting directions (for example, 10, 11, 12, 13, 14, and 15) as a target direction.

In an exemplary embodiment, the target direction may be specified by a user.

In another exemplary embodiment, the target direction may be predetermined. For example, the target direction may be previously designated in the direction shot first (i.e., the first shooting direction).

In another exemplary embodiment, the specification module 130 determines a shooting direction corresponding to a partial image shot a predetermined specific object among the first to the Nth partial images (e.g., 10-1, 11-1, 12-1, 13-1, 14-1, and 15-1) as the target direction.

For example, the specific object may be a person. The specification module 130 performs an image analysis for each of the first to the Nth partial images (e.g., 10-1, 11-1, 12-1, 13-1, 14-1, and 15-1) and specifies which of partial images include the specific object (e.g., person).

Then, the specification module 130 may determine a shooting direction corresponding to a partial image including a specific object (e.g., a person) as a target direction. For example, if a specific object (e.g., a person) is photographed in the second partial image 11-1 of FIG. 3, the specification module 130 may determine the second shooting direction 11 as the target direction.

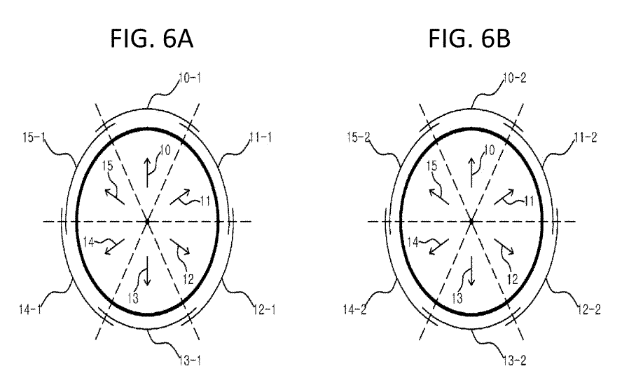

In another exemplary embodiment, the specification module 130 may determine a target direction by comparing pairs of partial images shot in the same shooting direction with a time difference, which will be described with reference to FIGS. 6A and 6B.

FIG. 6A shows six partial images first shot in six different shooting directions, and FIG. 6B shows six additional partial images further shot after partial images of FIG. 6A.

As shown in FIG. 6A, the first to sixth partial images 10-1, 11-1, 12-1, 13-1, 14-1, and 15-1 are images shot in the first shooting direction 10, 11, 12, 13, 14, and 15, respectively. A first additional partial image to the sixth additional partial images 10-2, 11-2, 12-2, 13-2, 14-2, and 15-2 are images shot in the first shooting directions 10, 11, 12, 13, 14, and 15, respectively. That is, the i-th partial image (i is an arbitrary natural number with 1<=i<=N) and the i-th additional partial image are both images taken toward the i-th shooting direction.

The first additional partial image to the Nth additional partial image (e.g., 10-2, 11-2, 12-2, 13-2, 14-2, and 15-2) may also be shot by the terminal 200 and the driving apparatus 210 of FIG. 4 in the same manner as FIG. 5.

The first additional partial image to the Nth additional partial image may be images shot at a time point after each corresponding partial image is shoot. For example, the terminal 200 shoots the first partial image through the Nth partial image (for example, 10-1 through 15-1) while a first 360 degree rotating, and shoots the first additional partial image to the Nth additional partial image (10-2, 11-2, 12-2, 13-2, 14-2, and 15-2) while a second 360 degree rotation.

Alternatively, the terminal 200 shoots the first partial image (for example, 10-1) toward the first shooting direction (for example, 10), and after a predetermined time elapses the terminal 200 shoots the first additional partial image (For example, 10-2), and then rotates in the second shooting direction (for example 11) and shoots the second partial image (e.g., 11-1), and after a predetermined time elapses the terminal 200 may shoot the second additional partial image (For example, 11-2). The Nth partial image and the Nth additional partial image can be taken in the same manner.

On the other hand, the image obtaining module 110 may obtain the first to Nth partial images (e.g., 10-1, 11-1, 12-1, 13-1, 14-1, and 15-1) as well as the first additional partial image to the Nth additional partial image 10-2, 11-2, 12-2, 13-2, 14-2, and 15-2 further shot in the first to Nth shooting directions (for example, 10, 11, 12, 13, 14, and 15).

Then, the specification module 130 may compare each of the first partial image to the Nth partial image with an additional partial image corresponding thereto to specify the target direction out of the first direction to the Nth direction.

In one embodiment, the specification module 130 calculates the difference between each partial image and its corresponding additional partial image, and determines the direction in which the partial image and the corresponding additional image is taken with the largest difference, as the target direction.

For example, the specification module 130 may calculate each difference between the first partial image 10-1 and the first additional partial image 10-2, the second partial image 11-1, and the second additional partial image 11-1-2), . . . , The sixth partial image 15-1 and the sixth additional partial image 15-2, respectively. If the difference between the second partial image 11-1 and the second additional partial image 11-2 is the largest, the specification module 130 can determine the second shooting direction 11 as the target direction.

Referring again to FIG. 2, the video frame obtaining module 140 may obtain a plurality of video frame images shot toward the target direction.

For example, the video frame obtaining module 140 may obtain the plurality of video frame images from the terminal 200. In this case, the terminal 200 may control the driving apparatus 210 to face the terminal 200 toward the target direction, and then shoot the plurality of video frame images.

The video generating module 150 generates a 360° video based on the plurality of video frame images obtained by the video frame obtaining module 140 and the 360° image generated by the image generating module 120.

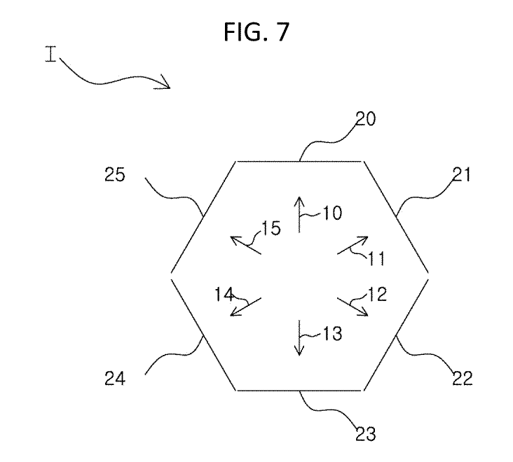

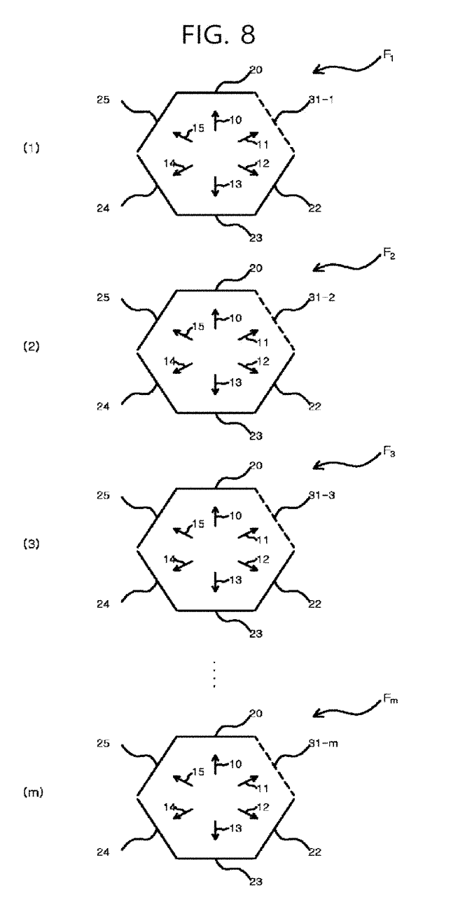

More specifically, for each of the plurality of video frame images the video generating module 150 may generate a 360° video frame, corresponding to each of the video frame images by registering the video frame image to the 360° image. This will be described with reference to FIGS. 7 and FIG. 8.

FIG. 7 is a diagram showing a 360° image according to an exemplary embodiment. FIG. 8 is a diagram showing each 360° video frame constituting a 360° video.

In embodiment of FIG. 7 and FIG. 8, it is assumed that the object direction is specified in the second shooting direction 11.

As described above, the 360° image is generated by registering the first partial image to the Nth partial image (for example, 10-1, 11-1, 12-1, 13-1, 14-1, and 15-1). Therefore, as shown in FIG. 7, the 360° image (I) may be composed of portions 20 to 25 corresponding to the first partial image to the Nth partial image, respectively.

Meanwhile, the video generating module 150 may register each video frame image to a portion 21 corresponding to the partial image shot in the target direction 11 among the 360° images (I).

Referring to FIG. 8, the video generating module 150 may generate a first 360° video frame F1 by registering the first video frame image to the portion of the 360° image (I) corresponding to the partial image shot in the target direction 11. Thus, the first 360° video frame F1 may include the portion 21 corresponding to the first partial image, the portions 23 to 25 corresponding to the third partial image to the sixth partial image, and the portion 30-1 corresponding to the first video frame image.

Also, the video generating module 150 may generate a second 360° video frame F2 by registering the second video frame image to the portion of the 360° image (I) corresponding to the partial image shot in the target direction 11. Thus, the second 360° video frame F2 may include the portion 21 corresponding to the first partial image, the portions 23, 24, and 25 corresponding to the third partial image to the sixth partial image, and the portion 30-2 corresponding to the second video frame image.

The video generating module 150 may generate up to a last 360° video frame Fm corresponding to the last video frame image in a similar manner. The last 360° video frame Fm also includes a portion 21 corresponding to the first partial image, a portion 23, 24, and 25 corresponding to the third partial image to the sixth partial image and a portion 30-m corresponding to the last video frame image.

On the other hand, in the example of FIGS. 7 and 8, the second partial image used for generation of the 360° image and each video frame image used for generation of each 360° video frame are all in the same direction (i.e., the second shooting direction, 11), various parameters required for the stitching process and the stitching process, and intermediate results derived from the stitching process can be very similar. Therefore, a part of the stitching process can be omitted or can be performed by a very simple operation. For example, distortion of an image is required to place an image of a plane in a sphere, and the same distortion transform applied to the second partial image is applied to each video frame image used for generation of each 360° video frame equally.

As described above, in each frame of the 360° video generated by the video generating module 150 there may not be any change in the remaining regions except the region corresponding to the partial image shot in the target direction and change may occur only in an area corresponding to the partial image shot in the target direction.

In the case of a typical 360° video, one 360° video frame is generated by registering all partial images taken in all directions. That is, a very large resource is required because all partial images taken in all directions must be registered always to generate a single 360° video frame. However, according to the technical idea, a partial image shot in a shooting direction other than the target direction is registered only once and fixed on each 360° video frame, and only the portion in the target direction is newly registered, so there is advantage of requiring much reduced resource.

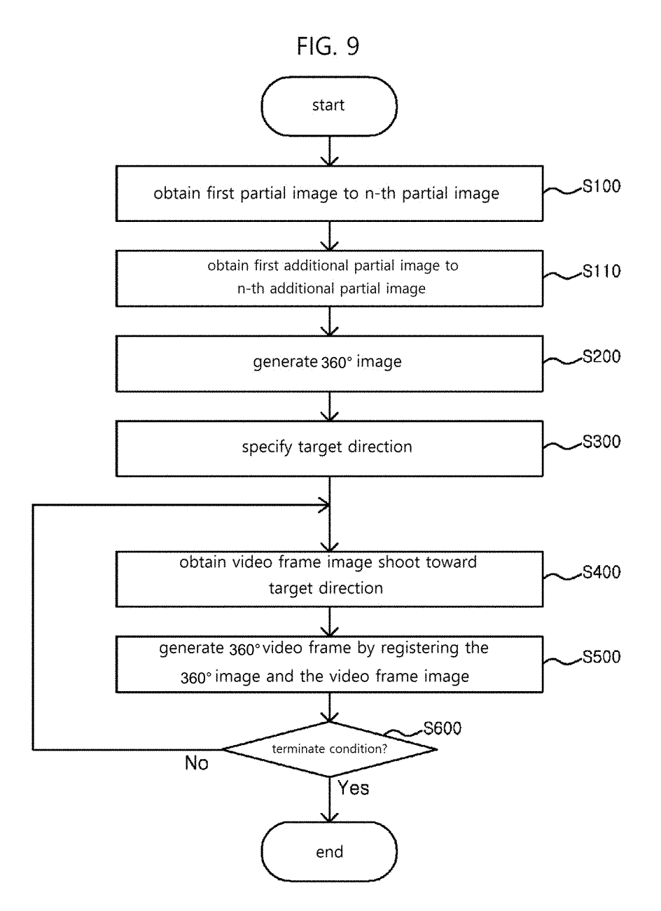

FIG. 9 is a flowchart illustrating a 360° video generation method according to an exemplary embodiment.

Referring to FIG. 9, the 360° video generation system 100 may obtain the first partial image to the Nth partial image (N is a natural number of 2 or more) to be registered (S100). In this case, the i-th partial image (i is an arbitrary natural number with 1<=i<=N) may be an image shot in the i-th photographing direction corresponding to the i-th partial image at a predetermined shooting position, and the first shooting direction to the N-th shooting direction are all different directions.

Optionally, the 360° video generation system 100 may obtain the first additional partial image to the Nth additional partial image (S110). Here, the i-th additional partial image (i is an arbitrary natural number with 1<=i<=N) may be an image shot from the shooting position toward the i-th shooting direction.

The 360° video generation system 100 may generate the 360° image by registering the first partial image to the Nth partial image (S200).

Meanwhile, the 360° video generation system 100 can specify a target direction that is one of the first to Nth shooting directions (S300). In one embodiment, the 360° video generation system 100 compares each of the first partial image to Nth partial image with the corresponding additional partial image and determine a shooting direction corresponding the partial image having the largest difference as the target direction.

Also, the 360° video generation system 100 may obtain video frame images shot toward the target direction (S400) and registered each of the obtained video frame images to the 360° image to generate a 360° video frame (S500).

Meanwhile, the 360° video generation system 100 may generate a 360° video frame until a predetermined termination condition (for example, generation of a completion signal, etc.) is satisfied (S600).

On the other hand, according to an exemplary embodiment, the 360° video generation system 100 may include a processor and a memory for storing a program executed by the processor. The processor may include a single-core CPU or a multi-core CPU. The memory may include high speed random access memory and may include non-volatile memory such as one or more magnetic disk storage devices, flash memory devices, or other non-volatile solid state memory devices. Access to the memory by the processor and other components may be controlled by the memory controller. Here, the program may cause the 360° video generation system 100 according to the present embodiment to perform the above-described 360° video generation method when being executed by a processor.

Meanwhile, the 360° video generation method according to the embodiment may be implemented in the form of a computer-readable program command and stored in a computer-readable recording medium. A computer-readable recording medium includes all kinds of recording apparatuses in which data that can be read by a computer system is stored.

The program instructions recorded on the recording medium may be those specially designed and constructed for the present invention or may be those known to those skilled in the software art.

Examples of the computer-readable recording medium include magnetic media such as a hard disk, a floppy disk and a magnetic tape, optical media such as CD-ROM and DVD, a floptical disk, And hardware devices that are specially configured to store and execute program instructions such as magneto-optical media and ROM, RAM, flash memory, and the like. The above-mentioned medium may also be a transmission medium such as optical or metal lines, wave guides, etc., including a carrier wave for transmitting a signal designating a program command, a data structure, and the like. The computer readable recording medium may also be distributed over a networked computer system so that computer readable code can be stored and executed in a distributed manner.

Examples of program instructions include machine language code such as those produced by a compiler, as well as devices for processing information electronically using an interpreter, for example, a high-level language code that can be executed by a computer.

The above-described hardware devices may be configured to operate as one or more software modules to perform the operations, and vice versa.

It is therefore to be understood that the above-described embodiments are illustrative in all aspects and not restrictive. For example, each component described as a single entity may be distributed and implemented, and components described as being distributed may also be implemented in a combined form.

According to an exemplary embodiment of the present disclosure, it is possible to provide a system and method capable of generating 360° video using a relatively reduced amount of resources.

In the case of a typical 360° video, one 360° video frame is generated by registering partial images taken in all directions. That is, a very large resource is required because all partial images taken in all directions must be registered to generate every 360° video frame. However, according to the technical concept, a partial images shot (or taken) in a shooting direction other than a target direction is registered only once and fixed on each 360° video frame, and only a portion corresponding to the target direction is newly registered. So it requires much smaller resources.

According to an exemplary embodiment, there is an effect that a 360° video can be generated easily and relatively accurately using a terminal carried by a user.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method for generating 360° video, the method comprising:
obtaining, by a 360 video generation system, a first partial image to an N-th partial image (N is a natural number greater than or equal to 2), wherein an i-th partial image (i is any natural number greater than or equal to 1 and smaller than or equal to N) is image shot toward i-th shooting direction at a predetermined shooting position, and a first shooting direction to a N-th shooting direction are all in different directions;
generating, by a 360° video system, a 360° image by registering the first partial image to the N-th partial image;
obtaining, by a 360° video system, a plurality of video frame images shot toward a target direction which is any one of the first shooting direction to the N-th shooting direction; and
generating a 360° video based on the plurality of video frame images and the 360° image.

2. The method for generating 360° video of claim 1, wherein the obtaining of the first partial image to the N-th partial image comprises:
obtaining, by a 360° video generation system, the first partial image to the Nth partial image shot on a terminal equipped with an image sensor,
wherein the terminal is configured to obtain the first partial image by shooting toward the first shooting direction at the shooting position, sequentially rotate and shoot a second partial image through the Nth partial image by controlling a driving apparatus coupled to the terminal and capable of rotating the terminal, and
wherein the terminal is configured to control, for shooting a j-th partial image (j is any natural number greater than or equal to 2 and smaller than or equal to N), the driving apparatus such that the terminal facing a (j−1)-th shooting direction after shooting a (j−1)-th partial image faces a j-th shooting direction, and obtain a j-th partial image by shooting toward the j-th shooting direction.

3. The method for generating 360° video of claim 1, wherein the obtaining of the first partial image to the N-th partial image comprises,
obtaining, by the 360° video generation system, the first partial image to the Nth partial image shot on a terminal equipped with an image sensor,
and wherein the method further comprises:
further obtaining a first additional partial image to the a N-th additional partial image further shoot at the terminal, wherein an i-th additional partial image (i is any natural number greater than or equal to 1 and smaller than or equal to N) is shot toward an i-th shooting direction at the shooting position; and
specifying the target direction which is any one of the first shooting direction to the N-th shooting direction by comparing each of the first partial image to the Nth partial image with the additional partial image corresponding thereto.

4. The method for generating 360° video of claim 1, further comprising,
determining, by the 360° video generation system, a specific shooting direction as the target direction wherein a partial image corresponding to the specific shooting direction among the first partial image to the Nth partial image is taken of a predetermined specific object.

5. The method for generating 360° video of claim 1, wherein the operation of generating 360° video based on the plurality of video frame images and the 360° image comprises, and
wherein for each of the plurality of video frame images, generating a 360° video frame corresponding to each of the plurality of video frame images by registering the 360° image and the each of the plurality of video frame images, by the 360° video generation system.

6. The method for generating 360° video of claim 5, wherein the operation of generating the 360° video frame corresponding to each of the plurality of video frame images by registering the 360° image and the each of the plurality of video frame images comprises,
generating the 360° video frame corresponding to each of the plurality of video frame images by registering each of the plurality of video frame images to a portion of the 360° image corresponding to partial image corresponding to the target direction.

7. A non-transitory computer-readable storage medium having stored thereon processor-executable instructions may be configured to cause a processor to perform the method of claim 1.

8. A 360° video generation system comprising,
a processor; and
a memory for storing a computer program executed by the processor;
wherein the computer program comprises instructions, when executed by the processor, configured to cause the 360° video generation system to execute the method of claim 1.

9. A 360° video generation system comprising:
an image obtaining module configured to obtain a first partial image to an N-th partial image (N is a natural number greater than or equal to 2), wherein an i-th partial image (i is any natural number greater than or equal to 1 and smaller than or equal to N) is image shot toward i-th shooting direction at a predetermined shooting position, and a first shooting direction to a N-th shooting direction are all in different directions;
an image generating module configured to generate a 360° image by registering the first partial image to the N-th partial image;
a video frame obtaining module configured to obtain a plurality of video frame images shot toward a target direction which is any one of the first shooting direction to the N-th shooting direction; and
a video generating module configured to generate a 360° video based on the plurality of video frame images and the 360° image.

10. The 360° video generation system of claim 9, wherein the image obtaining module is configured to obtain the first partial image to the N-th partial image shot on a terminal equipped with an image sensor,
wherein the terminal is configured to obtain the first partial image by shooting toward the first shooting direction at the shooting position, sequentially rotate and shoot a second partial image through the N-th partial image by controlling a driving apparatus coupled to the terminal and capable of rotating the terminal, and
wherein the terminal is configured to control, for shooting a j-th partial image (j is any natural number greater than or equal to 2 and smaller than or equal to N), the driving apparatus such that the terminal facing a (j−1)-th shooting direction after shooting a (j−i)-th partial image faces a j-th shooting direction, and obtain the j-th partial image by shooting toward the j-th shooting direction.

11. The 360° video generation system of claim 9, wherein the image obtaining module is configured to:
obtain the first partial image to the N-th partial image shot on a terminal equipped with an image sensor; and
obtain a first additional partial image to an Nth additional partial image further shot at the terminal, wherein an i-th additional partial image (i is any natural number greater than or equal to 1 and smaller than or equal to N) is shot toward the i-th shooting direction at the shooting position,
wherein the 360° video generation system further comprises a specification module configured to specify the target direction which is any one of the first shooting direction to the N-th shooting direction by comparing each of the first partial image to the N-th partial image with the additional partial image corresponding thereto.

12. The 360° video generation system of claim 9, further comprising a specification module configured to determine a specific shooting direction as the target direction wherein the partial image corresponding to the specific shooting direction among the first partial image to the Nth partial image is taken of a predetermined specific object.

13. The 360° video generation system of claim 9, wherein the video generation module, for each of the plurality of video frame images, is configured to generated a 360° video frame corresponding to each of the plurality of video frame images by registering the 360° image and the each of the plurality of video frame images.

14. The 360° video generation system of claim 13, wherein the video generation module, for generating the 360° video frame corresponding to each of the plurality of video frame images by registering the 360° image and the each of the plurality of video frame images, is configured to generate the 360° video frame corresponding to each of the plurality of video frame images by registering each of the plurality of video frame images to a portion of the 360° image corresponding to the partial image corresponding to the target direction.
